(19) United States
(12) Patent Application Publication
(10) Pub. No.: US 2016/0034174 A1
(43) Pub. Date: Feb. 4, 2016

(54) SYSTEM AND METHOD FOR SINGLE-TOUCH ENGAGEMENT WITH SOCIAL MEDIA AND OTHER SITES

(71) Applicant: Fortune Favors the Bold

(72) Inventor: Jeremy Greenfield, Ponca City, OK (US)

(21) Appl. No.: 14/812,768

(22) Filed: Jul. 29, 2015

Related U.S. Application Data
(60) Provisional application No. 62/030,243, filed on Jul. 29, 2014.

(51) Int. Cl. G06F 3/0488; H04L 29/08; G06F 17/30; G06F 3/0484

(52) U.S. Cl. CPC G06F 3/04883; G06F 3/0484; H04L 67/02; G06F 17/30867; G06F 17/30905; G06Q 50/01

(57) ABSTRACT

A mobile computing device running application software is provided that enables the aggregation of data from multiple sources into a single main feed, and is configured to receive touch input into the form of custom gestures. In an embodiment, a single gesture activates custom action related to data in the main feed. A system and method of use are provided for operating the system.

### PRIORITY CLAIM

This application claims priority to U.S. Patent Application No. 62/030,243, filed Jul. 29, 2014 and titled, “SYSTEM AND METHOD FOR SINGLE-TOUCH ENGAGEMENT WITH SOCIAL MEDIA AND OTHER SITES,” the contents of which is incorporated by reference in its entirety.

### BACKGROUND

Engagement with social media has been on the rise for several years and has reached a level where Americans aged 18-64 spend over three hours every day on Facebook, Instagram, Twitter, and other social media networks. Americans in the 18-34 age bracket are spending nearly four hours each day. In terms of total users, Instagram now boasts over 200 million subscribers, which appears small compared to Facebook's user base of 800 million.

The ability to share photographs is a key part of the social media experience. Instagram users have uploaded over 20 billion images to the site to be viewed by friends and acquaintances whereas Facebook receives nearly 200 million photo uploads every day.

The social media experience for a user can be overwhelming. With data coming in from multiple sources at once, a user may feel overloaded and limit engagement, an undesirable outcome for providers of these services.

The social media experience for a user also tends to be fragmented. A user wishing to engage with social media must go to one site for Facebook activity, followed by a different site for Twitter activity, and yet another for Instagram. The logging in and logging out can be fatiguing to the user or cause the user to lose interest. Negotiating multiple passwords and user names may also cause confusion and limit user engagement. Further, the ability of the various sites to track a user is compromised when the user logs out and switches to a different social media network.

Additionally, many social media sites do not readily enable the user to save content to their computer or mobile computing device. Saving may be desirable if the user wishes to preserve the information or send it to friends outside of the social networking environment, for example, to friends who do not participate in the particular social network.

Social media is merely one area of online engagement that has seen explosive growth, but generally lacks an optimized method of engagement using limited input.

As an example, mobile e-commerce is expected to surpass $100 billion in 2014 and polls show that over 80% of consumers plan to make a purchase using a mobile device, including tablets. These e-commerce retailers and other sites may be losing customers due to a cumbersome engagement process, particularly when the sites are accessed from a mobile device. Users must first access the pages, make selections, confirm their selections, and then check out, a process that can be frustrating on a mobile device.

Accordingly, a system is needed that allows a user to curate social media content so that only select information, or information meeting certain criteria is presented.

A system is further needed that will enable the user to view social media content from multiple sources in one location, either on one web site or in a single mobile application.

A system is further needed that will allow the user to save or store content outside of the social media network, such as for sharing or archiving.

A system is further needed that will enable users to engage with social media and other content, and save the same to a local device using a single or simplified touch or interaction.

A system is further needed that will enable users to engage with features of a web site or mobile app using a single or simplified touch or interaction, regardless of the application or environment.

### BRIEF DESCRIPTION OF THE DRAWINGS

The features and advantages of the present disclosure will be more fully understood with reference to the following detailed description when taken in conjunction with the accompanying figures, wherein:

FIG. 1 is a screenshot from an exemplary mobile application running on a mobile computing device according to embodiments of the invention;

FIG. 2 is a screenshot from an exemplary mobile application running on a mobile computing device and showing the data aggregation feature in embodiments of the invention;

FIGS. 3-5 are screenshots from an exemplary mobile application running on a mobile computing device showing the data save feature in embodiments of the invention;

FIG. 6 is a flowchart describing the data save function according to embodiments of the invention.

### SUMMARY

In some embodiments, a computing device may include a touch screen display, one or more processors, memory, a wireless transceiver, and/or mobile application software stored in the memory and configured to be executed by the one or more processors.

In some embodiments, the mobile application software is configured to selectively aggregate data elements from the one or more content servers and present the data elements in a main stream on the touch screen display.

In some embodiments, the mobile application software is configured to detect and respond to one or more finger contacts with the touch screen display.

In some embodiments, one of the data elements may be saved to the memory using a single stroke on the touch screen display.

In some embodiments, one of the data elements may be saved to the memory by the user pressing a finger to the touchscreen and holding the press for a mined interval.

In some embodiments, the content servers contain social media content.

In some embodiments, the content servers are accessed through an application programming interface.

In some embodiments, the main stream contains at least one of photographs, text, audio, and video collected from the social from the content servers.

In some embodiments, the mobile application software is further configured to permit a user to comment on one of the data elements and transmit the comment to the content server.

In some embodiments, the mobile application software is further configured to permit a user to filter the main stream according to one or more criteria.

In some embodiments, the data elements may include articles available for purchase.

In some embodiments, the articles may be purchased by using a single touch screen interaction.

In some embodiments, a computer-implemented method may include on a computing device with a touch screen display, executing mobile application software stored in a memory and configured to be executed by one or more processors; accessing one or more content servers to selectively retrieve content elements from the content servers; detecting one or more finger contacts with the touch screen display; and/or saving content elements from the content servers to the memory in response to the one or more finger contacts.

In some embodiments, a social media content aggregation system may include a mobile computing means and/or mobile application software stored in the memory and configured to be executed by the one or more processors. In some embodiments, the mobile computing means may include a touch screen display means, one or more processors, communication means. In some embodiments, the mobile application software is configured to aggregate data elements from the one or more content servers and present the data elements in a main stream on the touch screen display. In some embodiments, means for detecting user input indicating that the data element is to be saved to the memory.

### DETAILED DESCRIPTION

In embodiments, the system and method of the present invention comprises a mobile computing device and mobile application software installed on the mobile computing device. In embodiments, the system and method may involve remote servers that provide social media or other content.

In embodiments, as explained in detail below, the system and method may enable a user to engage with a web site or mobile app using a single or simplified touchscreen press or interaction to access features that could otherwise involve multiple steps, thereby increasing user engagement.

In embodiments, the mobile computing device may be any computing device on which a user can access the desired social media or other content. Such devices may include smartphones (e.g., the Apple iPhone, Samsung Galaxy, Nokia Lumia) tablet computers, (e.g., the Apple iPad, Samsung Galaxy Tab, Microsoft Surface), laptop computers, so-called “smart watches,” or any device on which a user may access the desired content, whether mobile or otherwise.

In a preferred embodiment, mobile computing device incorporates a touchscreen for receiving input from the user. In other embodiments, any conventional input system of a type known in the art may be employed such as a mouse, stylus, or keyboard.

A mobile application consistent with the present invention may be loaded on the mobile computing device according to the method prescribed by the device manufacturer. In embodiments, the mobile application may be preloaded on the mobile computing device by the manufacturer.

Alternatively, the system of the present invention may be implemented using a web browser such as Apple Safari, Google Chrome, or Mozilla Firefox, via a browser extension or plugin. While the description below uses a mobile computing device, such a device is merely exemplary and other types of devices are contemplated as coming within the scope of the invention.

In embodiments, a user may initiate the system by launching the app on the mobile device in the manner provider for by the mobile computing device operating system. In alternate embodiments, the user may initiate the system by going to a pre-defined URL, e.g., www.hasktack.co.

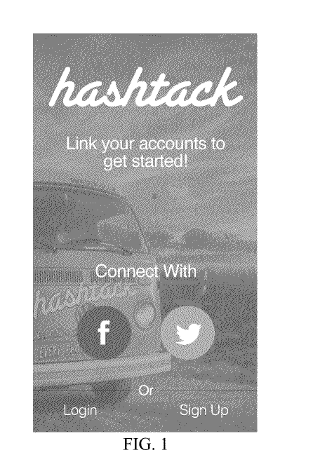

FIG. 1 below is an exemplary screenshot from an exemplary mobile application running on an Apple iPhone mobile computing device. It should be understood that representations of component of the system of the present invention on a particular device are meant to be exemplary and not limiting to any particular device.

As shown in FIG. 1, in embodiments, a user launching the mobile application for the first time may be asked to sign in to access content stored on remote social media servers. A user may select only one or multiple social media servers to engage using the system and method of the present invention.

In embodiments, and depending on the sites that the user selects, an authentication process may commence. Authentication will depend on the requirements of the individual social media servers and, preferably, will only occur during the initialization stage.

In embodiments, authentication may be realized through the social media server's application programming interface (“API”). For example, as shown in FIG. 1, a user may be given an option to connect with Facebook, another to connect with Twitter, and so forth. Upon selecting this option, a user may be taken to a server operated by the social media provider to confirm that the access is authorized. If the user confirms that the access is authorized, the social web server may provide authentication credentials, such as an API key, for subsequent access by the system of the present invention.

In embodiments, the API key may be an alphanumeric identifier. Data in the API key may identify the accessing system to the social media server, act as a unique identifier to permit access to the social media server, and identify a set of access privileges. For example, a user may elect to allow the system of the present invention to only access photographs on Instagram and Facebook, but not to delete or modify the photographs. In further embodiments, a user may authorize the mobile application to access the user's account(s) through a web browser on a personal computer.

The above steps may be repeated for all content sites that the user wishes to integrate into a unified stream and/or engage with using limited input.

Once the system has access privileges to the user's various social media accounts, in embodiments, the system may access those accounts and begin to gather data according to the privileges granted by the user, and system settings.

In embodiments, mobile application software waits for user input before engaging one or more social media servers. User input may be in the form of the user launching the mobile application, modifying filtering criteria, or any indication by the user that updated social media content is desired.

In embodiments, a parsing system may act as an intermediary between the mobile application software and the social media server.

In a preferred embodiment, the system of the present invention may utilize a parsing system to manage aggregation and storage of data from the user's social media sites. In embodiments, parsing system may be a backend as a service provider (“BaaS”) such as Parse (now owned by Facebook) that utilizes API keys to access select data from social media sites.

In embodiments, mobile application software engages parsing system via a communication link. Mobile application software may provide parsing system with specific instructions or categories of data to retrieve such as only Facebook data, or only photographs from the past week from all sites.

In embodiments, parsing system receives API key or authentication credentials, and presents those credentials to the social media server along with a request for data. In embodiments, the request for data may reflect the user's selections, all recent, data, data in a particular format, or any other selection.

In embodiments, parsing system may be integrated into social media server, or may be independent. In further embodiments, selection of social media may take place on the mobile computing device.

Further details of the parsing system will now be described. Parsing system may take the form of a conventional database that stores information from the mobile computing application and one or more social media servers in ordered rows and is sorted by some criteria such as date and time. Various social media data may be stored including API keys to access the various social media servers, analytical data about the user's preferences, and social media content itself, including photographs.

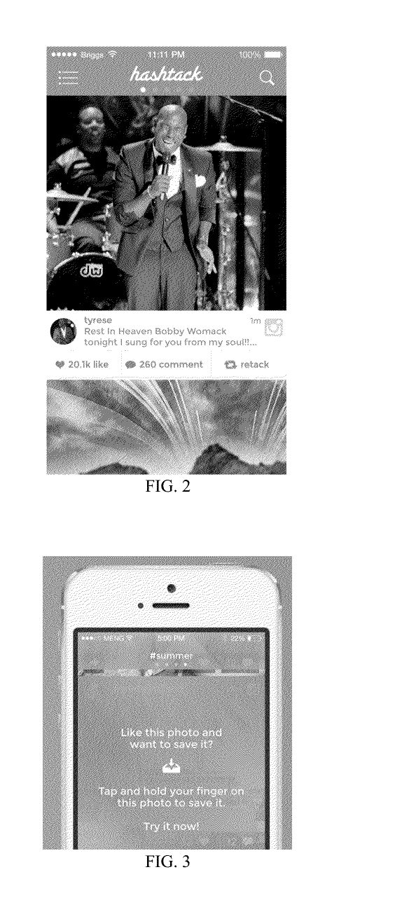

Referring to FIG. 2, content pulled from the user's authorized accounts is presented in the main application window in a unified stream, referred to as a main stream. In exemplary embodiments, the data pulled from the user's authorized accounts is limited to photographs. In alternate embodiments, the data may include videos, text, audio, or any other content that the user wishes to aggregate from multiple sources into a single unified stream.

As shown in FIG. 2, photographs from multiple sources are presented in the main stream for viewing by the user, as well as interaction by the user. In embodiments, mobile application may carry through commenting functions provided by the content providers. For example, referring to FIG. 2, the photographs, which are sourced from Instagram, include an icon to “like” to photograph, and another to provide comments on the photograph. Information provided through these buttons may be passed through to the Facebook site where the user's “like” or commentary will be visible by other Facebook users, regardless of whether or not they are using the mobile application of the present invention.

The foregoing feature is exemplary and not limited to Instagram. For example, functionality to retweet postings on Instagram may be integrated, as well as commentary on Instagram photos, LinkedIn, or any other social media interaction.

In embodiments, a legend adjacent the content indicates information about the content such as, for example, the author or poster, an image of the author or poster, the date of the posting, or the elapsed time since the posting.

In embodiments, an icon adjacent the content may indicate the source of that content. A small icon next to the elapsed time may indicate the source to be Instagram. Icons may be provided for any sites that are aggregated into the system of the present invention.

In embodiments, the main view may be filtered based upon criteria input by the user. In embodiments, filter controls may be provided within the mobile application itself.

In embodiments, a user may filter the main view by hash tag or keyword, such as a filtered view that only shows content tagged with the “#summer” hash tag. In such a configuration, only content in the user's authorized feeds containing the particular hash tag or keyword will be displayed.

In alternate embodiments, filtering may be done on other criteria such as user, date, popularity, number of comments, or any other metric that can be identified form the authorized content.

In embodiments, a user input monitor may run on mobile application device. The user input monitor may run in the background on the mobile computing device and listen for specific inputs or patterns from the user, and then act on those inputs or patterns. Once such input is the touch-and-hold described below.

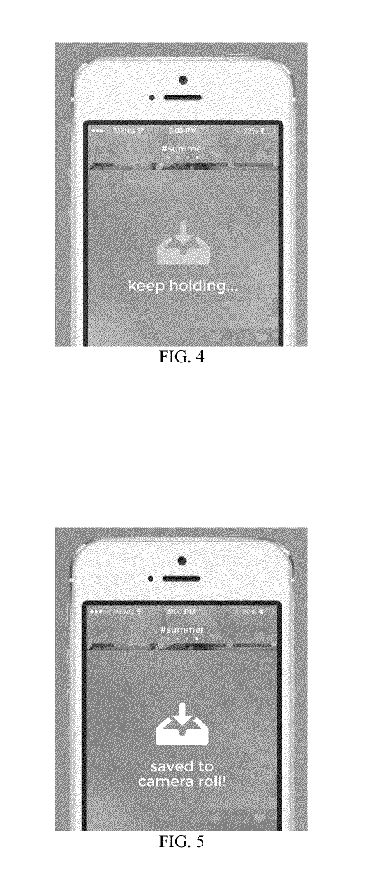

In embodiments, mobile application software allows a user to save images in the main view. Referring to FIG. 3, a user has engaged a photograph on the touchscreen of the mobile application by pressing a finger on the touchscreen and holding it in place until the mobile application responds.

In embodiments, the mobile application will recognize the touchscreen input and may prompt the user to save the photograph. In a preferred embodiment, the touch-to-save feature is invoked with a touchscreen press and hold. Alternative embodiments may include other touchscreen inputs (e.g., multiple fingers or patterns across the touchscreen), button presses, voice prompts, or the like. In embodiments, a mobile application may respond to other input such as a mouse click or the press of a stylus.

Referring to FIG. 3, in a preferred embodiment, the system responds to the touch and hold with a prompt asking the user whether the photograph should be saved. In a preferred embodiment, the photograph is saved to the local storage of the mobile computing device, although other configurations are contemplated such as, for example, cloud-based storage, transmission by e-mail or text message, re-posting on other social media sites.

In embodiments, the mobile application software may contact the social media server directly with the URL of the content to be saved, present the authentication credentials, and download the content to the memory of the mobile computing device, or other storage.

In embodiments, the mobile application may coach the user through the process. For example, upon detecting a touchscreen press on the mobile computing device, the mobile application software may present the user with visual or textual cues to aid in the process. The cues may be enjoyable to the user and may educate the user on how to operate the system, which may encourage further or expanded usage.

Referring to FIGS. 4 and 5, the mobile application device is shown instructing the user to continuing engaging the touchscreen for a period of time sufficient to alter the monitoring system that a save is desired. The user now understands what engagement pattern will save a photograph directly to the local storage on the mobile computing device, and may be encouraged to further use the system.

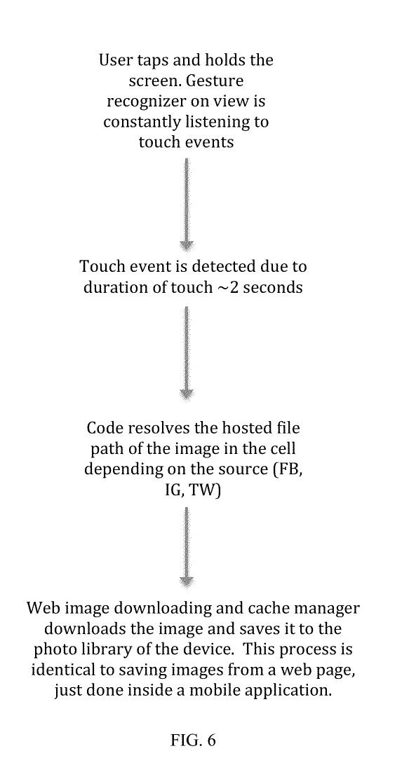

Referring to FIG. 6 below, a flowchart of a preferred embodiment of the image save function is shown.

The application of the touch-and-hold feature described above is not limited to photographs in a social media stream and can be employed in any environment where rapid engagement with the device is desirable.

For example, in embodiments, the touch-and-hold feature may be employed on an e-commerce site. A user viewing a product on the retailer web page may be given the option to touch-and-hold for immediate purchase and shipment to the user. In embodiments, touch-and-hold may be employed to load a user's virtual shopping cart and again when the user is ready to check out. The ease with which a user may engage reduces the time spent considering the purchase and may lead to increased spending. The ease with which a user may engage the site may also lead to repeat visits since the experience is easier to navigate than comparable sites.

In embodiments, the touch-and-hold feature may be used to save any content on a web page, whether it be photos, audio, video, or otherwise.

In alternative embodiments, the touch-and-hold feature may be utilized in applications beyond social media and e-commerce, in any application where rapid and streamlined interaction is desired.

In embodiments, the touch-and-hold feature may be employed to add or upload content to a site such as Facebook or Instagram. For example, a user wishing to upload a photo to a social media site could be given the option to touch-and-hold a relevant portion of the site to upload an image.

It will be understood that there are numerous modifications of the illustrated embodiments described above that will be readily apparent to one skilled in the art, such as many variations and modifications of the system and/or its components including combinations of features disclosed herein that are individually disclosed or claimed herein, explicitly including additional combinations of such features, or alternatively other types of components. Also, there are many possible variations in the components and configurations. These modifications and/or combinations fall within the art to which this invention relates and are intended to be within the scope of the claims, which follow. It is noted, as is conventional, the use of a singular element in a claim is intended to cover one or more of such an element.

It will be understood that there are numerous modifications of the illustrated embodiments described above which will be readily apparent to one skilled in the art, such as increasing or decreasing the number of filters, the components comprising the filters, the crossover slope, the number of speaker drivers, and any other combinations of features disclosed herein that are individually disclosed or claimed herein, explicitly including additional combinations of such features. These modifications and/or combinations fall within the art to which this invention relates and are intended to be within the scope of the claims, which follow. It is noted, as is conventional, the use of a singular element in a claim is intended to cover one or more of such an element.

We claim:

1. A computing device, comprising:
a touch screen display;
one or more processors;
memory;
a wireless transceiver; and
mobile application software stored in the memory and configured to be executed by the one or more processors;
wherein said mobile application software is configured to selectively aggregate data elements from said one or more content servers and present said data elements in a main stream on said touch screen display; and
wherein said mobile application software is configured to detect and respond to one or more finger contacts with the touch screen display.

2. The computing device of claim 1 wherein one of said data elements may be saved to said memory using a single stroke on said touch screen display.

3. The computing device of claim 1 wherein one of said data elements may be saved to said memory by the user pressing a finger to the touchscreen and holding the press for a predetermined interval.

4. The computing device of claim 1 wherein said content servers contain social media content.

5. The computing device of claim 1 wherein said content servers are accessed through an application programming interface.

6. The computing device of claim 1 wherein said main stream contains at least one of photographs, text, audio, and video collected from said social from said content servers.

7. The computing device of claim 1 wherein said mobile application software is further configured to permit a user to comment on one of said data elements and transmit said comment to said content server.

8. The computing device of claim 1 wherein said mobile application software is further configured to permit a user to filter said main stream according to one or more criteria.

9. The computing device of claim 1 wherein said data elements comprise articles available for purchase.

10. The computing device of claim 9 wherein said articles may be purchased by using a single touch screen interaction.

11. A computer-implemented method, comprising:
on a computing device with a touch screen display, executing mobile application software stored in a memory and configured to be executed by one or more processors;
accessing one or more content servers to selectively retrieve content elements from said content servers;
detecting one or more finger contacts with the touch screen display; and
saving content elements from said content servers to said memory in response to said one or more finger contacts.

12. The computer-implemented method of 11 wherein a content element may be saved to said memory using a single stroke on said touch screen display.

13. The computer-implemented method of 11 wherein a content element may be saved to said memory by the user by pressing a finger to the touchscreen and holding the press for a predetermined interval.

14. The computer-implemented method of 11 wherein said content elements are social media data.

15. The computer-implemented method of 11 wherein said content servers are accessed through an application programming interface.

16. The computer-implemented method of 11 wherein said main stream contains at least one of photographs, text, audio, and video collected from said social from said content servers.

17. The computer-implemented method of 11 wherein said mobile application software is further configured to permit a user to comment on one of said data elements and transmit said comment to said content server.

18. The computer-implemented method of 11 further comprising the step of filtering said main stream in response to a search criteria.

19. A social media content aggregation system, comprising:
a mobile computing means comprising a touch screen display means, one or more processors, communication means;
mobile application software stored in said memory and configured to be executed by said one or more processors;
wherein said mobile application software is configured to aggregate data elements from said one or more content servers and present said data elements in a main stream on said touch screen display; and
means for detecting user input indicating that said data element is to be saved to said memory.
